(19) United States
(12) Patent Application Publication
(10) Pub. No.: US 2013/0248087 A1
(43) Pub. Date: Sep. 26, 2013

(54) PROCESS FOR PRODUCING FIBROUS MATERIAL PRE-IMPREGNATED WITH THERMOSETTING POLYMER

(71) Applicants: Patrice Gaillard, Hagetaubin (FR); Mickael Havel, Wayne, PA (US); Alexander Korzhenko, Pau (FR)

(72) Inventors: Patrice Gaillard, Hagetaubin (FR); Mickael Havel, Wayne, PA (US); Alexander Korzhenko, Pau (FR)

(73) Assignee: ARKEMA FRANCE, Colombes (FR)

(21) Appl. No.: 13/885,700

(22) PCT Filed: Nov. 17, 2011
(86) PCT No.: PCT/FR11/52670

§ 371 Date: May 16, 2013

(30) Foreign Application Priority Data
Nov. 17, 2010 (FR) 1059446

(51) Int. Cl. B32B 37/02

(52) U.S. Cl. CPC B32B 37/02
USPC 156/180; 427/434.6; 427/180; 427/385.5; 427/389.8; 427/392; 427/389.9; 427/393.5; 156/433

(57) ABSTRACT

A method for producing a fibrous material including carbon fibres or glass fibres or plant fibres or polymer-based fibres, that are used alone or in a mixture, and are impregnated by a thermohardenable polymer using a mixture containing a hardener and carbon nanofillers, such as carbon nanotubes (CNT). A mixture containing said nanofillers, such as CNTs, and the hardener is used to introduce said nanofillers into the fibrous material. A continuous production line (L) for producing the material in the form of at least one calibrated and homogeneous strip (20) of reinforcing fibres impregnated with a thermohardenable polymer, includes the device (100) for arranging two series of fibres (1, 2) used to form a strip in such a way as to arrange the two series of fibres such that they are brought into contact with each other by means of two calendering devices.

The present invention relates to a process for manufacturing a pre-impregnated fibrous material and the uses of such fibrous materials.

The expression “fibrous materials” is understood to mean an assembly of reinforcing fibers which may be either short fibers such as felts or nonwovens that may be in the form of strips, sheets, braids, rovings or fragments, or continuous fibers such as for example in 2D fabrics, UD fibers or nonwovens.

The fibers that may be incorporated into the composition of the material are more especially carbon fibers, glass fibers, mineral fibers such as basalt, silicon carbide, polymer-based fibers, plant fibers, cellulose fibers such as viscose, flax, hemp, silk, sisal, used alone or as a mixture.

The invention relates more particularly to the manufacture of fibrous materials impregnated by a thermosetting polymer, otherwise known as a thermosetting resin (the two terms meaning the same thing) or a blend of thermosetting polymers (or resins) and the uses of such materials referred to as pre-impregnated fibrous materials, for the manufacture of composite materials that are used for producing three-dimensional (3D) parts.

Indeed, fibrous materials pre-impregnated with a polymer are used in the manufacture of structural parts for machines, in particular moveable machines, with a view to lightening them while giving them a mechanical strength comparable to that obtained with metal structural parts and/or to ensure thermal protection and/or to ensure the discharging of electrostatic charges. These fibrous materials may be impregnated with a thermoplastic polymer or with a thermosetting polymer.

The pre-impregnated fibrous materials may also contain conductive nanofillers of carbon origin such as carbon nanotubes (or CNTs), carbon black, nanofibers or graphenes, more particularly carbon nanotubes (CNTs).

The presence of carbon nanotubes in the fibrous material makes it possible to improve the mechanical and/or thermal and/or electrical properties of the mechanical parts based on said material.

Thus, the pre-impregnated fibrous materials form light materials that provide a mechanical strength comparable to metal, giving an increase in the electrical and/or thermal resistance of the mechanical part produced in order to ensure the discharging of the heat and/or of the electrostatic charge. These materials are particularly suitable for the simple production of any three-dimensional, commonly symbolized by 3D, mechanical structure, in particular for motor vehicles, aeronautics, the nautical field, railroad transport, sport or aerospace.

The invention applies to the production of parts having a 3D structure, such as in particular aircraft wings, the fuselage of an aircraft, the hull of a boat, the side members or spoilers of a motor vehicle or else brake disks, a cylinder body or steering wheels, using pre-impregnated fibrous materials.

In the manufacture of fibrous materials impregnated by a thermosetting resin (that is to say by a thermosetting polymer) or a blend of thermosetting polymers, the impregnation takes place at the melting temperature Tm of the resin as the minimum temperature or at a higher temperature. This temperature Tm varies depending on the resins used. After the step of impregnating the material, the resin is in a stable state which enables a shaping of the material for the manufacture of three-dimensional parts. The shaping may be carried out just after impregnation or subsequently. The curing agent or element for the activation of the crosslinking reaction which has been introduced into the thermosetting resin remains inactive as long as its reaction temperature is not reached. This temperature is above the glass transition temperature Tg of the (crosslinked) resin and is above the melting temperature Tm (of the resin before crosslinking) if it exists. For the production of parts having a three-dimensional structure, the fibrous materials are shaped and heated at a temperature at least equal to the glass transition temperature Tg of the resin. The resin is converted to a thermoset resin and the part thus takes on its final shape.

To date, when nanofillers such as CNTs are introduced into the thermosetting resin, they are in fact dispersed in the base formulation of the resin, that is to say in the thermosetting resin or resin composition containing the curing agent.

The Applicant has observed in this case that the presence in the resin of nanofillers, in particular such as CNTs, poses several technical problems to be solved. Firstly, the dry handling thereof in the form of a pulverulent powder of nanometer size presents risks for health, safety and the environment in general for users in plants for producing pre-impregnated fibrous materials. Secondly, the introduction of these nanofillers, in particular CNTs, leads to the formation of aggregates, requiring the use of particular, very high shear mixers in order to break them up with a risk of heating and premature crosslinking of the resin in the presence of the curing agent. Similarly, these nanofillers, due to their size (large specific surface area) and their interactions with the resin, lead to a significant increase in the viscosity of the medium. This significantly limits the amount of nanofillers, in particular the amount of CNTs, which it is possible to incorporate into a thermosetting resin that already contains the curing agent, without using the particular methods of high-shear dispersion with the cited drawbacks.

Failing a solution to the cited problems, the presence in the resin of nanofillers, such as CNTs, gives rise to a formation of under-crosslinked domains that contribute to the reduction of the glass transition temperature Tg of the resin with respect to the temperature specified by the manufacturers and, consequently, a modification with reduction of the thermomechanical performances directly linked to the Tg, and of the electrical performances (conductivity) via the heterogeneity of the material. One of the reasons or possible explanations is that the portion of thermosetting resin remains adsorbed on the surface of the CNTs and therefore it is no longer available to the crosslinking reaction in order to participate in the crosslinked network. The formation of under-crosslinked domains then contributes to the reduction of the glass transition temperature and of the thermomechanical performances (Auad et al., Poly. Engin. Sci. 2010, 183-190).

The objective of the present invention is to overcome this problem. It makes it possible to avoid the formation of under-crosslinked domains and to maintain a high glass transition temperature Tg of the thermosetting resin (thermosetting polymer or blend of thermosetting polymers).

For this purpose, it is proposed according to the invention to use a mixture containing nanofillers, in particular carbon nanotubes and the curing agent, that is to say nanofillers predispersed separately in the curing agent, in order to introduce the carbon nanotubes, by means of this mixture, into the fibrous material, more specifically by the final impregnation of this material.

Thus, according to the invention, the nanofillers are introduced into the thermosetting polymer, not alone, but by means of the nanofillers/curing agent mixture. In accordance with the invention, the nanofillers/curing agent mixture may be introduced directly into the thermosetting polymer before impregnation of the fibrous material or else may be incorporated into the fibrous material during the impregnation.

The nanofillers/curing agent mixture may be in the form of a fluid, powder, fibers or film, depending on the curing agent and on the amount of nanofillers. When the nanofillers/curing agent mixture is incorporated into the fibrous material before impregnation, this mixture will preferably be produced either in the form of fibers, or in the form of a film, or in the form of a powder. Thus, when the nanofillers/curing agent mixture is in the form of fibers, these fibers will advantageously be in the assembly of fibers forming the fibrous material. When the mixture is in the form of a powder, it will be deposited on the fibrous material. When the mixture is in the form of a film, it will advantageously be deposited on the fibrous material. The fibrous material thus obtained is then impregnated by the thermosetting polymer. It is furthermore apparent to the Applicant that this invention could also be applied to carbon-based conductive nanofillers other than carbon nanotubes and in particular to carbon black, to carbon nanofibers or to graphenes, which are also capable of posing safety problems due to their pulverulent nature and which have an ability to confer improved conductive or mechanical properties on the materials into which they are incorporated.

One subject of the present invention is more particularly a process for manufacturing a fibrous material comprising an assembly of one or more fibers, composed of carbon fibers or glass fibers or plant fibers or mineral fibers or cellulose fibers or polymer-based fibers, used alone or as a mixture, impregnated by a thermosetting polymer or a blend of thermosetting polymers containing a curing agent and nanofillers of carbon origin such as carbon nanotubes (CNTs), carbon black, carbon nanofibers or graphenes, mainly characterized in that a mixture containing the nanofillers of carbon origin such as CNTs and the curing agent (nanofillers predispersed in said curing agent) is used in order to introduce said nanofillers into the fibrous material. The nanofillers of carbon origin/curing agent mixture advantageously comprises a content of nanofillers of between 10% and 60%, preferably of between 20% and 50%, relative to the total weight of the mixture.

The nanofillers of carbon origin/curing agent mixture may also comprise a crosslinking catalyst or accelerator. Various types of crosslinkings and, as a function thereof, corresponding curing agents may be considered according to the present invention, for example:
by polycondensation or by polyaddition between two co-reactive functions with the curing agent being that of the 2 components which is the least viscous and/or has the lower molecular weight, with a possibility of a crosslinking reaction that is accelerated by catalysis (presence of a catalyst); or
by radical crosslinking via opening of ethylenically unsaturated groups, the curing agent being, in this case, the radical initiator, of peroxide type, including hydroperoxide, with the optional presence of an accelerator for the decomposition of the peroxide, such as a tertiary amine or CO²⁺ or Fe²⁺ salts.

In one preferred exemplary embodiment, the nanofillers of organic origin, hereinafter referred to as nanofillers, consist of carbon nanotubes (CNTs).

The expression “thermosetting resin” is considered to mean the main multifunctional resin of a two-component (2K) system that can be crosslinked by condensation, addition or by opening of ethylenically unsaturated groups via a radical route or via other ionic or other crosslinking routes. The other reactive component of this system corresponds to the definition of curing agent according to the invention which corresponds to the least viscous and/or lower molecular weight component in said two-component system. In the case where the thermosetting resin comprises crosslinkable ethylenically unsaturated groups, said curing agent is, for example, a radical initiator, in particular a peroxide initiator, which term signifies, for the invention, either a peroxide or a hydroperoxide. With a hydroperoxide type initiator, decomposition accelerators may be used, such as tertiary amines and cobalt (2+) or iron (2+) salts.

The term “curing agent” is understood, within the meaning of the present invention, to mean a compound capable of giving rise to a chemical crosslinking and of resulting in a three-dimensional polymer network, by means of irreversible crosslinking bonds of covalent type, which once obtained can no longer be converted by the action of heat, with said three-dimensional network being infusible by heating and insoluble in a solvent. This compound is therefore firstly a crosslinking agent for said thermosetting resin. This compound is in general the least viscous and/or lower molecular weight compound, in particular among the two components of a two-component crosslinkable system.

The curing agent is therefore an often polyfunctional compound bearing, for example, amine, anhydride or alcohol or isocyanate or epoxy functions that are reactive with respect to co-reactive functions borne by a thermosetting resin. The expression “thermosetting resin” is understood, within the meaning of the present invention, to mean a polymer that can be chemically crosslinked by a curing agent, into a thermoset resin which has a three-dimensional structure and is infusible and insoluble, which once obtained can no longer be converted by the action of heat. In other words, a thermosetting resin, once the three-dimensional polymer network is formed, becomes a thermoset polymer network which will no longer flow under the effect of heat (absence of creep), even with a supply of shearing (via shear) mechanical energy.

The thermosetting resins to be crosslinked using the curing agent according to the invention comprise: epoxy resins, polyesters and unsaturated polyesters, vinyl esters, phenolic resins, polyurethanes, cyanoacrylates and polyimides such as bismaleimide resins, aminoplasts (resulting from the reaction of an amine such as melamine with an aldehyde such as glyoxal or formaldehyde) and mixtures thereof, without this list being limiting. It should be noted that the unsaturated polyesters, vinyl esters or acrylated multifunctional resins crosslink by opening at least two ethylenically unsaturated groups in the presence of a radical initiator which, in this case, acts as curing agent, in general in the presence of an ethylenic comonomer such as acrylic or vinylaromatic monomers. The preferred radical initiator is of peroxide type, this term including peroxides and hydroperoxides. The decomposition of the peroxide initiator, and in particular of the hydroperoxide initiator, may be accelerated in the presence of a decomposition accelerator such as a tertiary amine or a cobalt (²⁺) or iron (²⁺) salt.

The impregnation may be carried out by placing, according to a first option, the fibrous material in a fluid bath of thermosetting polymer(s) into which the nanofillers/curing agent mixture (nanofillers predispersed in the curing agent) is introduced or has been introduced.

The impregnation may also be carried out by placing the fibrous material in a fluidized bed, the thermosetting polymer or the blend of thermosetting polymers being in powder form, and also the nanofillers/curing agent mixture.

The impregnation may also be carried out by directly extruding a stream of thermosetting polymer containing the nanofillers/curing agent mixture over the fibrous material which is in the form of a sheet or strip or braid.

It is also possible to envisage the pre-impregnation of the fibrous material with the curing agent/nanofillers mixture before the deposition of the thermosetting polymer (resin).

Furthermore, in another exemplary embodiment, the impregnation consists in:
i) using at least two series of different fibers, a first series of continuous fibers forming the reinforcing fibers of said material and a second series of fibers consisting of (uncrosslinked) thermosetting polymer containing the nanofillers/curing agent mixture and having a melting temperature Tm;
ii) placing the two series of fibers in contact with one another; then
iii) heating the set of the two series of fibers to a temperature at least equal to the melting temperature Tm of the thermosetting fibers and leaving the set to cool to ambient temperature, the melting temperature Tm being below the reaction temperature of the curing agent and below the melting temperature of the fibers of the first series.

The reinforcing fibers constituting the first series may be mineral fibers or organic fibers of thermoplastic or thermosetting polymer or else a mixture of mineral fibers and organic fibers of thermoplastic or thermosetting polymer.

The invention also relates to an appliance for implementing the process in which the impregnation consists in using two series of fibers, the impregnation of the reinforcing fibers forming the first series taking place directly by melting at a temperature Tm of the thermosetting polymer fibers which have been brought into contact.

Advantageously, the appliance comprises a line for continuous formation of said material in the form of at least one calibrated and homogeneous strip made of (mineral or organic) reinforcing fibers impregnated with thermosetting polymer, comprising the device for positioning at least one set of two series of fibers used to form a strip, so as to place the two series of fibers in contact with one another, this device being provided with a first calendering device and comprising a shaping device, provided with a second calendering device, provided with two rolls comprising at least one pressing section of desired width, in order to obtain, via pressure, a strip that is calibrated in width during its passage through the rolls.

When the two series of fibers are heated at the melting temperature Tm of the thermosetting polymer fiber, they are also shaped in order to obtain a homogeneous material having a shape and dimensions calibrated in the form of a strip.

For the simultaneous formation of several width-calibrated and homogeneous strips of pre-impregnated fibrous material, the appliance comprises inlets for several sets of two series of fibers and several sections for shaping and width-calibrating the strips.

The invention also relates to the uses of fibrous materials pre-impregnated by a composition containing a thermosetting polymer or a blend of thermosetting polymers and a mixture of nanofillers, such as carbon nanotubes, and of curing agent, for the manufacture of parts having a three-dimensional structure.

This use comprises a step of shaping the pre-impregnated fibrous materials, combined with a heating of said materials to a temperature at least equal to the glass transition temperature Tg of the thermosetting polymer, in order to activate the reaction of the curing agent, that is to say to crosslink the polymer in order to render the composition thermoset (i.e. crosslinked) and give the part its final shape.

In practice, several methods may be used for the manufacture of three-dimensional (3D) parts.

In one example, the shaping of the fibrous materials may consist in positioning the pre-impregnated fibrous materials on a preform, in staggered rows and so that they are at least partly superposed until the desired thickness is obtained and in heating by means of a laser which also makes it possible to adjust the positioning of the fibrous materials relative to the preform, the preform then being removed.

According to other examples, the shaping of the pre-impregnated materials is carried out by one of the following known techniques:
calendering,
laminating,
pultrusion,
low-pressure injection Molding® or else,
the technique of filament winding,
infusion,
thermocompression,
RIM or S-RIM.

Other distinctive features and advantages of the invention will appear clearly on reading the description which is provided below and which is given by way of illustrative and nonlimiting example and with regard to the figures in which:

FIG. 1 represents the diagram of an appliance for implementing the process in the case where the impregnation is carried out by melting a series of thermosetting fibers, in contact with a series of reinforcing fibers;

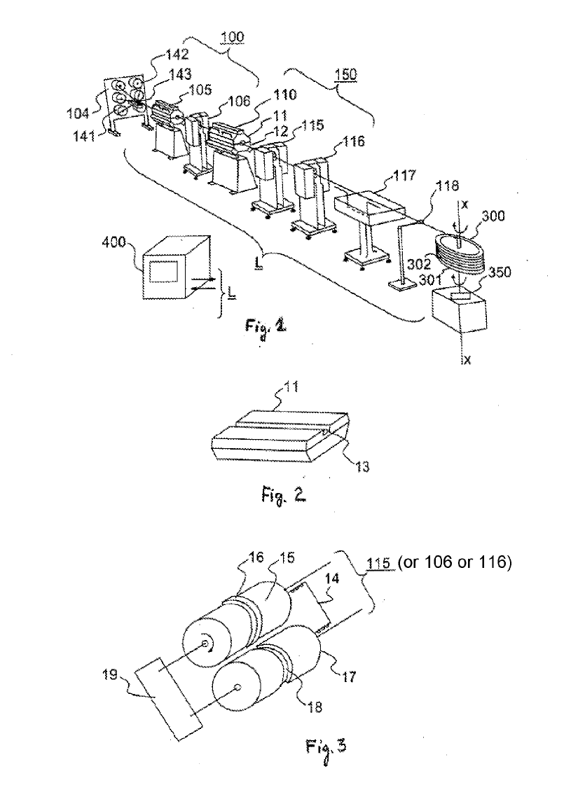

FIG. 2 represents the diagram of a half-furnace with the groove for placing the fibers;

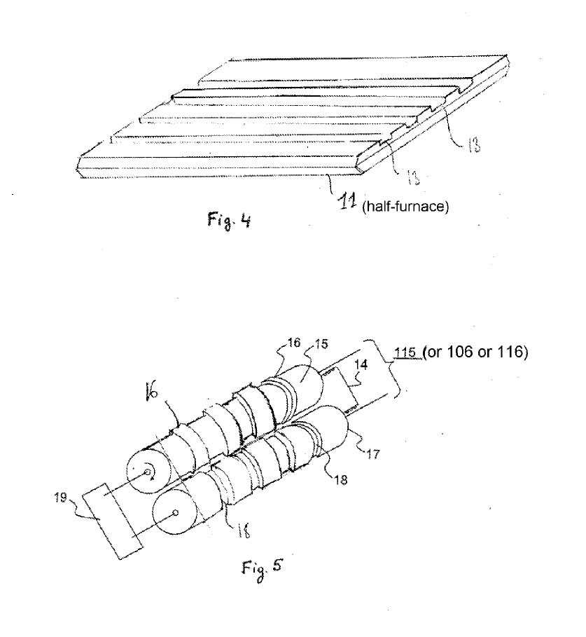

FIG. 3 represents the diagram of the calendering rolls with the complementary elements for calibrating and shaping the material in the form of a strip;

FIG. 4 represents the diagram of a half-furnace with several grooves for placing the fibers;

FIG. 5 represents the diagram of the calendering rolls with several complementary elements for calibrating and shaping the material into several strips.

In the remainder of this description, the expression “nanofiller of carbon origin”, intended to be mixed with the curing agent according to the invention, denotes a filler comprising at least one element from the group formed of carbon nanotubes, carbon nanofibers, carbon black, graphenes, graphite or a mixture thereof in any proportions. Preferably, the size of the particles of these nanofillers does not exceed 150 nm, it being possible for these particles to be in the form of aggregates of particles that do not exceed 10 μm (microns). The nanofillers of carbon origin are referred to hereinbelow as nanofillers.

According to the invention, it is proposed to introduce nanofillers such as carbon nanotubes (CNTs) by means of a mixture containing a reactive compound that makes it possible to achieve the crosslinking of the thermosetting resin and the nanofillers when this (resin) is heated at a temperature at least equal to the crosslinking temperature. In a known manner, the reactive compound comprises at least one curing agent or a composition of curing agents. It may also comprise an accelerator or a catalyst. Reference will subsequently be made, for simplicity, to curing agent.

### I) The Nanofillers/Curing Agent Mixture:

The mixture contains nanofillers and the curing agent or a combination of curing agents, chosen as a function of the resin used in a known manner for a person skilled in the art. Thus, the nanofillers/curing agent mixture may comprise additives, for example compounds which will be inert with respect to the crosslinking reaction (such as solvents) or on the contrary reactive solvents or diluents that will control the crosslinking reaction by adjusting certain mechanical properties of the final thermoset resin, and also catalysts or accelerators that make it possible to accelerate the crosslinking of the reactive components.

As additives to the nanofillers/curing agent mixture, it is possible to have a thermoplastic polymer or a thermoplastic polymer blend, such as for example a polyamide (PA), a polyetherimide (PEI) or a solid epoxy.

When an accelerator or a catalyst is present in the mixture, it is also chosen in a known manner for a person skilled in the art as a function of the resin used.

The nanofillers of carbon origin/curing agent mixture advantageously comprises a content of nanofillers of between 10% and 60%, preferably of between 20% and 50%, relative to the total weight of the mixture.

Carbon nanotubes (CNTs) have particular crystalline structures, of tubular shape, that are hollow and closed off, composed of atoms positioned regularly as pentagons, hexagons and/or heptagons, obtained from carbon. CNTs in general consist of one or more rolled graphite sheets. A distinction is thus made between single-walled nanotubes (or SWNTs) and multiwalled nanotubes (or MWNTs). Double-walled nanotubes may especially be prepared as described by Flahaut et al. in Chem. Comm. (2003), 1442. Multiwalled nanotubes may, for their part, be prepared as described in document WO 03/02456. It is preferred, according to the invention, to use multiwalled CNTs.

The carbon nanotubes used according to the invention customarily have a mean diameter ranging from 0.1 to 200 nm, preferably from 0.1 to 100 nm, more preferably from 0.4 to 50 nm and better still from 1 to 30 nm, and advantageously a length of more than 0.1 μm and advantageously of from 0.1 to 20 nm, for example around 6 μm. Their length/diameter ratio is advantageously greater than 10 and usually greater than 100. These nanotubes therefore comprise, in particular, what are known as VGCF (vapor grown carbon fiber) nanotubes. Their specific surface area is for example between 100 and 300 m²/g and their bulk density may in particular be between 0.01 and 0.5 g/cm³ and more preferably between 0.07 and 0.2 g/cm³. The multiwalled carbon nanotubes may for example comprise from 5 to 15 sheets and more preferably from 7 to 10 sheets.

An example of raw carbon nanotubes is the trade name Graphistrength® C100 from Arkema.

Carbon nanofibers, like carbon nanotubes, are nanofilaments produced by chemical vapor deposition (CVD) from a carbon-based source which is decomposed over a catalyst comprising a transition metal (Fe, Ni, Co, Cu) in the presence of hydrogen, at temperatures from 500° C. to 1200° C. However, these two carbon-based fillers differ due to their structure (I. Martin-Gullon et al., Carbon 44 (2006) 1572-1580). Specifically, carbon nanotubes consist of one or more graphene sheets wound concentrically about the axis of the fiber in order to form a cylinder having a diameter of from 10 to 100 nm. In contrast, carbon nanofibers are composed of relatively organized graphitic regions (or turbostratic stacks), the planes of which are inclined at variable angles with respect to the axis of the fiber. These stacks may take the form of platelets, herringbones or stacked cups in order to form structures that have a diameter ranging generally from 100 nm to 500 nm, or even more.

Furthermore, carbon black is a colloidal carbon-based material manufactured industrially by incomplete combustion of heavy petroleum products, which is in the form of spheres of carbon and aggregates of these spheres, the dimensions of which are generally between 10 and 1000 nm.

Graphenes are isolated and individualized sheets of graphite, but very often assemblies comprising between one and a few tens of sheets are referred to as graphenes. Unlike carbon nanotubes, they have a more or less planar structure, with corrugations due to thermal agitation that are even greater when the number of sheets is reduced. A distinction is made between FLGs (few layer graphenes), NGP (nanosized graphene plates), CNS (carbon nanosheets), and GNRs (graphene nanoribbons).

Graphite is characterized by a crystalline structure composed of carbon atoms organized in regular planes of hexagons. Graphite is available for example under the brands Timrex or Ensaco.

The curing agent is chosen as a function of the nature of the thermosetting resin and of its method of crosslinking (or its reactivity) in a two-component reactive (in fact co-reactive) system, for example by (poly) condensation or by (poly)addition or by crosslinking via the opening of ethylenically unsaturated groups via a radical route or (crosslinkable) by other routes. If the thermosetting resin bears functions that are reactive by condensation or by addition, said curing agent bears co-reactive functions, that is to say functions capable of reacting with the functions borne by said thermosetting resin, respectively by condensation and addition. The thermosetting resin and the curing agent thus form a two-component reactive system having a mean reactive functionality of greater than 2 in order to be crosslinkable. In the case of thermosetting resins that are crosslinkable via the opening of ethylenically unsaturated groups via a radical crosslinking route or another route, at least two ethylenically unsaturated groups per polymer chain are present. In this case, the curing agents may for example be radical initiators, such as the family of peroxide compounds which may be peroxides or hydroperoxides. The latter may break down into free radicals, either by raising the temperature (via a thermal effect), but also at low temperature by the use of a reducing agent which is an accelerator of the radical decomposition of the initiator and is commonly known as an accelerator in thermosetting (crosslinkable) compositions of this type.

Therefore, as a function of the thermosetting resins and reactive functions borne, the curing agents that can be used according to the invention may comprise amines, derivatives obtained by reaction of urea with a polyamine, acid anhydrides, organic acids, polyols and mixtures thereof, without this list being limiting.

As amines that can be used, mention may be made of aliphatic amines such as cyclohexylamine, linear ethylene polyamines such as ethylenediamine, diethylenetriamine (DETA), triethylenetetramine (TETA) and tetraethylenepentamine (TEPA), cycloaliphatic amines such as 1,2-diaminocyclohexane, isophorone diamine, N,N′-disopropyl isophorone diamine and hexamine, aromatic amines such as benzylamine, diethyltoluene-diamine (DETDA), metaphenylenediamine (MPDA), diaminodiphenylmethane (DDM), diaminodiphenylsulfone (DDS), dicyanodiamide (DICY such as Dyhard 100SF from AlzChem), 4,4′-diaminodiphenylsulfone, 4,4′-methylene-dianiline, 4,4′-methylenebis(ortho-chloroaniline) (MBOCA), and oligomers of polyamines (for example Epikure 3164 from Resolution).

As derivatives obtained by the reaction of urea with a polyamine, mention may be made of 1-(2-aminoethyl)imidazolidone, also known as 1-(2-amino-ethyl)imidazolidin-2-one (UDETA), 1-(2-hydroxy-ethyl)imidazolidone (HEIO), 1-(2-[(2-amino-ethyl)amino]ethyl)imidazolidone (UTETA), 1-[(2-{2-[(2-aminoethyl)amino]ethyl}amino)ethyl]imidazolidone (UTEPA), N-(6-aminohexyl)-N′-(6-methyl-4-oxo-1,4-dihydropyrimidin-2-yl)urea (UPy).

As anhydrides, mention may be made of phthalic anhydrides and derivatives such as phthalic anhydride, dichlorophthalic anhydride, tetrachlorophthalic anhydride, tetrahydrophthalic anhydride, methyl hexahydrophthalic anhydride (MHHPA), methyl tetrahydrophthalic anhydride (MTHPA, such as Aradur 917 from Huntsman), methyl hexahydrophthalic anhydride (HHPA), methyl nadic anhydride (MNA), dodecenyl succinic anhydride (DDSA) and maleic anhydride.

As organic acids, mention may be made of organic acids such as oxalic, succinic, citric, tartaric, adipic, sebacic, perchloric and phosphoric acids, disulfonic acids such as m-benzenedisulfonic acid, p-toluenesulfonic acid, methanedisulfonyl chloride or methanedisulfonic acid.

As organic phosphates, mention may be made of monomethyl orthophosphate, monoethyl orthophosphate, mono-n-butyl orthophosphate and monoamyl orthophosphate.

As polyols that can be used as curing agents in particular with isocyanate resins, mention may be made of glycerol, ethylene glycol, trimethylolpropane, pentaerythritol, polyether polyols, for example those obtained by condensation of an alkylene oxide or of a mixture of alkylene oxides with glycerol, ethylene glycol, trimethylolpropane, pentaerythritol and polyester polyols, for example those obtained from polycarboxylic acids, in particular oxalic acid, malonic acid, succinic acid, adipic acid, maleic acid, fumaric acid, isophthalic acid, and terephthalic acid, with glycerol, ethylene glycol, trimethylolpropane and pentaerythritol.

The polyether polyols obtained by addition of alkylene oxides, in particular ethylene oxide and/or propylene oxide, to aromatic amines, in particular the mixture of 2,4- and 2,6-toluenediamine, are also suitable.

As other compounds that may be used as curing agents according to the invention, mention may also be made of isocyanates such as bis-4-phenyldiisocyanate, phenolic derivatives such as the product DEH 85 from Dow, adducts of ethylene oxide or propylene oxide with a polyamine such as DETA, for example hydroxyethyldiethylenetriamine, the polyether amines sold by Huntsman under the trade name Jeffamine® D-2000 and T-403, the DGEBA-aliphatic amines adducts with an excess of amine functions relative to the glycidyl functions, polyamidoamines, for example Versamid® 140 from Cognis Corp., and Epikure® 3090 from Hexion, polyamides such as Epikure® 3090 and Epikure® 3100-ET-60 from Hexion, the amidoamines obtained by condensation between a fatty acid and a polyamine such as Ancamide®-260A® and Ancamide® 501 from Air Products, “flexibilized” polyamides such as Epikure® 3164 from Hexion, polymercaptans such as Capcure® 3830-81 from Cognis Corp., Mannich bases obtained by reaction between (poly)amine, formaldehyde and (alkyl)phenols such as Epikure® 190, 195 and 197 from Hexion, ketimines, for example Epikure® 3502 from Hexion, epoxy resin base polyols that can crosslink polyisocyanates, for example Epikote® 1007 and 1009 from Hexion.

As another compound that may be used as a curing agent, in particular for thermosetting resins containing ethylenically unsaturated groups, mention may also be made of organic peroxides/hydroperoxides with their matrices (often organic solvents since peroxides are never packaged pure), as mentioned below. For example, cumene hydroperoxide (Luperox® CU50VE from Arkema containing 50% of organic solvents) may be chosen.

### Catalyst and Accelerator

The catalyst is chosen from: substituted benzoic acids such as salicylic, 5-chlorobenzoic or acetylsalicylic acids. Sulphone-containing (or sulfonic) acids such as m-benzenedisulfonic acid.

The accelerator (in particular the accelerator for decomposition of a hydroperoxide) may be chosen from: tertiary amines such as dimethylaminoethyl phenol (DMP), benzyldimethyl aniline (BDMA), monoethyl amine associated with boron trifluoride (MEA-BF3), imidazoles such as 2-ethyl-4-methylimidazole, and metal alcoholates.

### II) The Thermosetting Polymers Also Referred to as Thermosetting Resins

The expression “thermosetting polymers” or else “thermosetting resin” is understood to mean a material that is generally liquid at ambient temperature or has a low melting point which is capable of being cured, generally in the presence of a curing agent, under the effect of heat, an accelerator, a catalyst or a combination of these elements, in order to obtain a thermoset resin. This (thermoset resin) consists of a material containing polymer chains of variable length bonded together by covalent bonds so as to form a three-dimensional network. Regarding its properties, this thermoset resin is infusible and insoluble. It may be softened by heating it above its glass transition temperature (Tg) but exhibits no creep and once a shape has been given to it, it cannot be subsequently reshaped by heating.

The Thermosetting Polymers are Chosen from:
unsaturated polyesters, epoxy resins, vinyl esters, phenolic resins, polyurethanes, cyanoacrylates, multifunctional acrylate resins and polyimides, such as bismaleimide resins, aminoplasts (resulting from the reaction of an amine such as melamine with an aldehyde such as glyoxal or formaldehyde) and mixtures thereof.

Among the thermosetting resins, those comprising epoxy, acid or isocyanate units are preferred, such as those which lead to thermoset networks of epoxy, polyester or polyurethane type being obtained by reaction with a curing agent bearing respectively an amine, acid or alcohol function. More particularly still, the invention applies to thermosetting epoxy (or epoxidized) resins that are crosslinkable in the presence of a curing agent of amine (including polyamine, polyamide amine and polyether amine) type or of anhydride type.

Regarding epoxy resins to be crosslinked using the curing agent according to the invention, mention may be made, by way of example, of epoxidized resins having a functionality, defined as the number of epoxide (or oxirane) functions per molecule, at least equal to 2, such as bisphenol A diglycidyl ether, butadiene diepoxide, 3,4-epoxycyclohexylmethyl 3,4-epoxycyclohexanecarboxylate, vinylcyclohexene dioxide, 4,4′-di(1,2-epoxyethyl)diphenyl ether, 4,4′-(1,2-epoxyethyl)biphenyl, 2,2-bis(3,4-epoxycyclo-hexyl)propane, resorcinol diglycidyl ether, phloroglucinol diglycidyl ether, bis(2,3-epoxycyclopentyl)ether, 2-(3,4-epoxy)cyclohexane-5,5-spiro(3,4-epoxy)cyclohexane-m-dioxane, bis(3,4-epoxy-6-methylcyclohexyl) adipate, N,N′-m-phenylenebis(4,5-epoxy-1,2-cyclohexane-dicarboxamide), a diepoxy compound containing a hydantoin ring. Such resins may generally be represented by the formula:

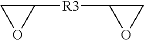

in which R3 is a group of formula —CH₂—O—R4—O—CH₂— in which R4 is a divalent group chosen from alkylene groups having from 2 to 12 carbon atoms and those comprising at least one substituted or unsubstituted aliphatic or aromatic ring.

Use may also be made of polyepoxidized resins comprising three or more epoxide groups per molecule, such as for example p-aminophenol triglycidyl ether, polyaryl glycidyl ethers, 1,3,5-tri(1,2-epoxy)benzene, 2,2′,4,4′-tetraglycidoxybenzophenone, tetraglycidoxy-tetraphenylethane, the polyglycidyl ether of the phenol/formaldehyde resin of novolac type (polyepoxidized novalacs), epoxidized polybutadiene, glycerol triglycidyl ether, trimethylolpropane triglycidyl ether and tetraglycidyl-4,4′-diamino-diphenylmethane.

The epoxy resins generally require as curing agent an acid anhydride or an amine.

The saturated polyester and unsaturated polyester resins are obtained by reaction of a polyacid (or corresponding anhydride) with a polyol. Said polyacid is saturated for the saturated polyesters and ethylenically unsaturated for the unsaturated polyesters. Mention may be made, as polyacid, of: succinic acid, pentanedioic acid, adipic acid, maleic acid (unsaturated), fumaric acid (unsaturated), itaconic acid (unsaturated) and also the anhydrides of these acids, heptanedioic acid, octanedioic acid, azelaic acid, sebacic acid, undecanedioic acid, dodecanedioic acid, brassylic acid, tetradecanedioic acid, hexadecanedioic acid, octadecanedioic acid, octadecenedioic acid, eicosanedioic acid, docosanedioic acid and fatty acid dimers containing 36 carbon atoms (C₃₆) or C₅₄ fatty acid trimers.

The fatty acid dimers or trimers mentioned above are (dimerized/trimerized) fatty acid oligomers obtained by oligomerization or polymerization of unsaturated monobasic fatty acids comprising a C₁₈ long hydrocarbon-based chain (such as linoleic acid and oleic acid), as described in particular in document EP 0 471 566.

When the diacid is cycloaliphatic, it may comprise the following carbon-based backbones: norbornylmethane, cyclohexylmethane, dicyclohexylmethane, dicyclohexyl-propane, di(methylcyclohexyl), di(methylcyclo-hexyl)propane.

When the diacid is aromatic, it is chosen from phthalic acid, terephthalic acid, isophthalic acid, tetrahydrophthalic acid, trimellitic acid and naphthalenic (or naphthenic) diacids, and also the corresponding anhydrides of these acids.

Among the polyols, compounds of which the molecule comprises at least two hydroxyl groups which make it possible to react with polyacids in order to obtain polyesters, mention may be made of ethylene glycol, propylene glycol, butylene glycol, 1,6-hexamethylene glycol, diethylene glycol, dipropylene glycol, neopentyl glycol, triethylene glycol, glycerol, trimethylolethane, trimethylolpropane, pentaerythritol, 1,3-trimethylene glycol, 1,4-tetramethylene glycol, 1,8-octamethylene glycol, 1,10-decamethylene glycol, 1,4-cyclohexanedimethanol, polyether diols such as PEG, PPG or PTMG, carboxylic diacid units such as terephthalic acid and glycol (ethanediol) or butanediol units.

Unsaturated polyesters resulting from the polymerization by condensation of dicarboxylic acids containing an ethylenically unsaturated compound (such as maleic anhydride or fumaric acid) and of glycols such as propylene glycol are preferred. They are generally cured in dilution in a reactive monomer such as styrene, by reaction of the latter with the unsaturated groups present on the polyester chain, generally with the aid of a curing agent chosen from organic peroxides including hydroperoxides, either via a thermal effect (heating), or in the presence of a decomposition accelerator of tertiary amine or cobalt (2+) salt, such as cobalt octoate, or iron (2+) salt type.

The vinyl esters comprise the products of the reaction of epoxides with (meth)acrylic acid. They may be cured after dissolving in styrene (in a manner similar to the polyester resins) using organic peroxides, like the unsaturated polyesters.

As regards the isocyanate resins to be crosslinked according to the invention, mention may be made of hexamethylene diisocyanate (HMDI), trimethylhexamethylene diisocyanates (TMDIs) such as 2,2,4-trimethylhexamethylene diisocyanate and 2,4,4-trimethylhexamethylene diisocyanate, undecane triisocyanates (UNTIs), 2-methylpentane diisocyanate, isophorone diisocyanate, norbornane diisocyanate (NBDI), 1,3-bis(isocyanatomethyl)cyclohexane (hydrogenated XDI), 4,4′-bis(isocyanatocyclo-hexyl)methane (H12MDI), 2,4- or 2,6-toluene diisocyanate (TDI), diphenylmethane diisocyanates (MDIs), 1,5-naphthalene diisocyanate (NDI), p-phenylene diisocyanate (PPDI), adducts comprising at least two isocyanate functions and that are formed by condensation between compounds comprising at least two isocyanate functions among those mentioned and compounds bearing other functions that react with the isocyanate functions, such as for example hydroxyl, thiol or amine functions. More particularly, as thermosetting resins bearing isocyanate functions, mention may be made of isocyanate-terminated prepolymers resulting from the reaction of a diisocyanate in excess and of a diol or of an oligomer (polyether, polyester) diol or resulting from a diisocyanate in excess and a diamine or an oligomer diamine (polyether-amine, polyamide-amine).

Among the polyisocyanates, mention may be made of modified polyisocyanates such as those containing carbodiimide groups, urethane groups, isocyanurate groups, urea groups or biurea groups.

Polyols that make it possible to react with the polyisocyanates are used as curing agents for obtaining polyurethanes and polyamines in order to obtain polyureas.

### III) The Fibers of the Fibrous Materials

The fibers constituting the fibrous materials may be mineral or organic fibers, such as for example carbon fibers, glass fibers, mineral fibers such as basalt, silicon carbide, polymer-based fibers, for example such as aromatic polyamides or aramids or polyolefins, cellulose fibers such as viscose, plant fibers such as flax, hemp, silk, and sisal, used alone or as a mixture.

### Examples of Processes for Impregnating the Fibrous Material

The impregnation may be carried out by placing the fibrous material in a fluid bath of thermosetting polymer(s), into which the nanofillers/curing agent mixture is introduced. The term “fluid” is understood, within the meaning of the present invention, to mean a medium which flows under its own weight and which has no specific shape (unlike a solid), for instance a liquid which may be more or less viscous or a powder put into suspension in a gas (for example air) generally known under the term “fluidized bed”.

When the fibrous materials are in the form of a strip or sheet, they may be put into circulation in the fluid, for example liquid, bath of thermosetting polymer.

The impregnation may be carried out according to a fluidized-bed impregnation process in which the polymer composition, namely the polymer or the blend of polymers containing the nanofillers/curing agent mixture, is in powder form. For this, the fibrous materials are passed into fluidized bed impregnating baths of polymer particles containing the nanofillers/curing agent mixture and these impregnations are optionally dried and may be heated in order to complete the impregnation of the polymer on the fibers or fabrics, and calendered if necessary.

It is also possible to deposit the polymer containing the nanofillers/curing agent mixture and that is in powder form, directly onto the fibrous materials placed flat on a vibrating support, in order to enable the distribution of the powder over the fibrous materials.

As another variant, it is possible to directly extrude a stream of polymer containing the nanofillers/curing agent mixture onto the fibrous material that is in the form of a sheet or strip or braid and to carry out a calendering operation.

When the nanofillers/curing agent mixture is introduced directly into the fibrous material, the impregnation may be carried out by placing the fibrous material in a fluidized bed, with the thermosetting polymer or the blend of thermosetting polymers that is in powder form. The impregnation may be carried out by placing the fibrous material in a fluid bath of thermosetting polymer(s) or else by depositing a film of thermosetting polymer on the fibrous material, then calendering and heating.

In the case where the nanofillers/curing agent mixture is introduced directly in powder form after grinding into the fibrous material, the assembly may rest on a vibrating plate for example in order to distribute the powder properly. The impregnation step is advantageously carried out by depositing a film of thermosetting polymer on the fibrous material, then calendering and heating.

According to another example, the fibrous material is formed from a first series of fibers constituting the mineral or organic reinforcing fibers and from a second series of thermosetting polymer fibers containing the nanofillers/curing agent mixture, having a melting temperature Tm (before crosslinking) below the melting temperature of the fibers of the first series and below the glass transition temperature Tg of the (crosslinked) thermosetting polymer. The two series of fibers are brought into contact and the impregnation is carried out by heating up to the melting temperature Tm of the second series of fibers (thermoset polymer fibers).

The thermosetting polymers (or resins) that are incorporated into the composition of the thermosetting fibers according to this exemplary embodiment are chosen from: unsaturated polyesters, epoxy resins, vinyl esters, multifunctional acrylate monomers or oligomers (MFA), (multifunctional) acrylic/acrylate resins, phenolic resins, polyurethanes, cyanoacrylates and polyimides, such as bismaleimide resins, aminoplasts (resulting from the reaction of an amine such as melamine with an aldehyde such as glyoxal or formaldehyde) and mixtures thereof.

Example of an Appliance for Manufacturing a Fibrous Material in the Case where the Impregnation is Carried Out by Melting Fibers of a Thermosetting Polymer or of a Blend of Thermosetting Polymers

In this exemplary embodiment of a pre-impregnated material, when the two series of fibers are heated at the melting temperature Tm of the fibers of the second series, they are also shaped in order to obtain a homogeneous material of calibrated shape and dimensions with the appliance as described below.

The positioning of the two series of fibers and the shaping of the material impregnated with molten thermosetting fibers (fibers from the second series) are advantageously carried out by a system comprising the implementation of calendering operations.

Preferably, several successive calendering operations are carried out in order to refine the shaping of the material and to obtain a defect-free homogeneous material, that is to say a homogeneous material without granularity and without air bubbles.

Preferably, the appliance illustrated by the diagram from FIG. 1 comprises a line for the continuous formation of said material in the form of a calibrated and homogeneous strip of reinforcing fibers, for example mineral reinforcing fibers, impregnated with thermosetting polymer according to the invention. The continuous formation line comprises a device for positioning the two series of fibers equipped with a first calendering device.

According to one embodiment, the appliance comprises a line L for continuous formation of the material in the form of a calibrated and homogeneous strip, described below in connection with FIGS. 1, 2 and 3.

In one embodiment variant, the line L for continuous formation of the material is designed to simultaneously form several calibrated and homogeneous strips, as will be described in connection with FIGS. 4 and 5.

This continuous formation line L comprises:
a device 100 for positioning the fibers which is equipped with:
   a device 104 for unwinding the fibers, this device 104 comprises reels 141 of fibers for the fibers of the first series and reels 142 for the fibers of the second series. In practice, there are as many reels as fibers and a pay-out device 143;
   a preheating device 105; it comprises two half-furnaces with horizontal opening, and infrared ramps. Its length is 1 m. The maximum temperature that can be reached is 600° C. The passage groove 13 has a cross section of 40×40 mm approximately;
   a calendering device 106; it comprises two rolls as illustrated in FIG. 3, having a diameter of 100 mm, a width of 100 mm and a polished chrome-plated surface with Ra less than 0.1 micron. The surface of the rolls 15 and 17 possesses male and female elements 16 and 18. The shape of these elements is suitable for fitting one inside the other, by pressure, so as to calibrate the strip 10 in terms of width, when it passes through the rolls. Preferably, the width of the strip is from 3 mm to a few tens of mm and for example 6 mm. This device comprises electric heating providing a maximum temperature at around 260° C., a cartridge heater with a rotating supply manifold and control via a thermocouple probe at the surface, a self-aligning bearing and a gap that can be adjusted from 0 to 2 mm by a nut and bolt, a synchronous drive of the two rolls via a chain or timing belt, a gear motor with brushless servomotor making it possible to have a maximum line speed of 30 m/minute and an electrical synchronization with the haul-off line;
a shaping device 150 equipped with:
   a heating device 110 identical to the preheating device 105. The temperature of this device is controlled in order to reach the melting temperature Tm of the thermoplastic polymer fibers. The half-furnace 11 comprises a passage groove 13 represented in FIG. 4,
   a second calendering device 115;
   a third calendering device 116;
   these calendering devices are identical to the first calendering device 106. The details of the structure of the roll are illustrated in the diagram of FIG. 3;
a cooling device 117: it is in the form of a 1 m long tank made of stainless steel into which the strip is introduced and submerged in cold water if necessary (the strip is represented as dotted lines in the crossing of the tank). It comprises a compressed air dryer and a water refrigeration unit of approximately 3 kW;
a device 118 for controlling the winding and supporting the strip that prevents vibrations and that performs movements from top to bottom over a height corresponding to the width of the winding reels 300;
a winding device 300: this device comprises several flat reels in the form of flat spools such as 301, 302, having a diameter of around 600 mm. The flat spools are superposed about a vertical axis XX as they are filled. Provision is made to store 10 to 20 flat spools with an interlayer between them. The passage from one flat spool 301 to the next 302 is carried out manually. The synchronization with haul-off of the strip is carried out by a control pad. The tension is controlled by the counterweight of the pad;
a haul-off line 350 makes it possible to pull off the strip continuously. It comprises elastomer rolls and makes it possible to exert a set pressure via a pneumatic cylinder. It is synchronized electrically with the calendering devices.

The continuous formation line L is managed via a control station 400, of computer type with a display screen. This station 400 is connected via a network for example to the various electric control devices of the line: electric motors, variable speed drives and speed and temperature regulators, motor of the haul-off line in order to enable the various synchronizations necessary for the continuous operation of the line L. This control station also makes it possible to record all the parameters for the management of the automatic operations and synchronization.

In the case where the reinforcing fibers 1 used have a coating (or sizing) layer, the coating layer may be removed if necessary, that is to say in the event of incompatibility with the thermosetting polymer fibers according to the invention to be melted. The coating layer will be removed before the two series of fibers 1, 2 are brought into contact. For this purpose, provision may be made for the fibers of the two series to arrive via two separate pay-out devices, so that the desizing is carried out on the reinforcing fibers before contact between the two series of fibers or provision may be made for the desizing of the reinforcing fibers to be carried out in a furnace, such as the furnace 105, before the two series of fibers are brought into contact in the furnace 105.

In addition, in order to obtain improved melting and impregnation, it is possible to use a heating device 110 of laser type instead of an infrared furnace. In the case of laser heating, the laser device is arranged so that the laser beam arrives in the longitudinal axis of the fibers (of the tape), that is to say the haul-axis. Thus, the heating is direct and therefore concentrated on the fibers.

Preferably, the heating device 110 is of induction or microwave heating type.

Specifically, an induction or microwave heating device is particularly suitable when electrically conductive fibers are present in the assembly or when electrically conductive fillers such as CNTs are present in the pre-impregnated material. This is because, in the case of induction or microwave heating, the electrical conductivity of the latter is employed and contributes to curing at the core being obtained and to a better homogeneity of the fibrous material. The thermal conduction of the fibers of the assembly or of the CNT fillers present in the pre-impregnated fibrous material also contributes, with this type of heating, to a curing at the core which improves the homogeneity of the material.

Microwave or induction heating, very particularly suitable in the presence of fillers such as carbon nanotubes CNTs in the pre-impregnated material, makes it possible to obtain a better dispersion/distribution of the CNTs within the material, resulting in the physicochemical properties having a better homogeneity and, consequently, the final product having better properties overall.

The pre-impregnated fibrous materials of a composition containing a thermosetting polymer or a blend of thermosetting polymers and a CNT/curing agent mixture according to the invention are particularly suitable for the manufacture of three-dimensional parts.

For this, the materials are shaped and heated at a temperature at least equal to the glass transition temperature Tg of the thermosetting polymer, in order to activate the reaction of the curing agent, that is to say to crosslink the polymer in order to render the composition thermoset and give the part its final shape.

In practice, several methods can be used for the manufacture of three-dimensional parts.

In one example, the shaping of the fibrous materials may consist in positioning the pre-impregnated fibrous materials on a preform, in staggered rows and so that they are at least partly superposed until the desired thickness is obtained and in heating by means of a laser which also makes it possible to adjust the positioning of the fibrous materials relative to the preform, the preform then being removed.

In another example, the pultrusion method is used. The fibrous material, which is in the form of unidirectional fibers or strips of fabrics, is placed in a bath of thermosetting resin(s) that is then passed into a heated die where the shaping and the crosslinking (the curing) take place.

According to other examples, the shaping of the pre-impregnated materials is carried out by one of the following known techniques:
calendering,
laminating,
the pultrusion technique,
low-pressure injection Molding® or else,
the technique of filament winding,
infusion,
thermocompression,
RIM or S-RIM.

It is thus possible to produce parts having a two-dimensional and three-dimensional structure such as, for example, aircraft wings, the fuselage of an aircraft, the hull of a boat, the side members or spoilers of a motor vehicle or else brake disks, cylinders or steering wheels.

In practice, the fibrous material may be heated by laser heating or a plasma torch or nitrogen torch or an infrared oven or else by microwaves or by induction. Advantageously the heating is carried out by induction or by microwaves.

This is because the conductivity properties of the pre-impregnated material containing conductive fibers and/or filled with conductive particles such as CNTs are advantageous in combination with induction or microwave heating since then the electrical conductivity is employed and contributes to curing at the core being obtained and to better homogeneity of the fibrous material. The thermal conduction of the fillers such as CNTs present in the pre-impregnated fibrous material also contributes, with this type of heating, to curing at the core which improves the homogeneity of the substrate.

Induction heating is obtained, for example, by exposing the substrate to an alternating electromagnetic field using a high frequency unit of 650 kHz to 1 MHz.

Microwave heating is obtained, for example, by exposing the substrate to a hyperfrequency electromagnetic field using a hyperfrequency generator of 2 to 3 GHz.

The Tg may be measured by dynamic mechanical analysis (DMA) at a frequency of 1 Hz and with a rise in temperature of 2° C. per minute and with a stabilization time of 30 seconds every 2° C. before the measurement. The Tm may be measured by DSC (differential scanning calorimetry).

### EXPERIMENTAL SECTION

Example 1 is presented in order to illustrate the present invention.

### Example 1

### Preparation of an Epoxy-Amine Thermosetting Composite According to the Invention

In a first step, a curing agent/CNT mixture is prepared with a polyamine curing agent according to the following procedure:

Introduced into the first feed hopper of a BUSS® MDK 46 co-kneader (L/D=11), equipped with an extrusion screw and a granulating device are Graphistrength® C100 carbon nanotubes from Arkema. The curing agent of the type of a mixture of polyamines (Aradur® 5052 from Huntsman) is injected in liquid form at ambient temperature into the second zone of the co-kneader. After kneading, at the outlet of the take-up extruder a solid mixture is obtained exiting the die, containing 25% of CNTs and 75% of curing agent. This mixture is then used as is or after dilution in the same curing agent, depending on the targeted CNT content, for the manufacture of an epoxy-amine/glass fibers composite, by infusion.

A few minutes before the infusion step, the curing agent/CNT (1% CNT) liquid mixture is introduced into the thermosetting resin (Araldite LY 5052 from Huntsman) with a weight ratio of 38 parts of curing agent per 100 parts of resin. The mixing is carried out using a blade mixer at ambient temperature and at a speed of 100 rpm for a few seconds.

The reactive mixture containing three components (thermosetting resin-curing agent-CNTs) is then infused under vacuum into a three-dimensional network of glass fibers, consisting of a stack of 8 two-dimensional plies (fabrics) of glass fibers. After curing of the resin obtained after 1 hour at ambient temperature, a composite is obtained composed of 50 vol % of glass fibers and 50 vol % of CNT-filled thermoset resin.

1. A process for manufacturing a fibrous material comprising an assembly of one or more fibers, composed of carbon fibers or glass fibers or plant fibers or mineral fibers or cellulose fibers or polymer-based fibers, used alone or as a mixture, the fibrous material being impregnated by a thermosetting polymer or a blend of thermosetting polymers, the fibrous material containing a curing agent and nanofillers of carbon origin,
the method comprising introducing a mixture containing the nanofillers of carbon origin and the curing agent into the fibrous material in order to introduce said nanofillers into the fibrous material.

2. The process for manufacturing a fibrous material comprising an assembly of one or more fibers as claimed in claim 1, wherein the nanofillers/curing agent mixture is in the form of fluid, fibers, powder or film.

3. The process for manufacturing a fibrous material comprising an assembly of one or more fibers as claimed in claim 1, wherein the nanofillers/curing agent mixture is introduced directly into the thermosetting polymer or the blend of thermosetting polymers used to impregnate the fibrous material.

4. The process for manufacturing a fibrous material comprising an assembly of one or more fibers as claimed in claim 1, wherein the nanofillers/curing agent mixture is introduced into the fibrous material before impregnation, in the form of fibers incorporated into the assembly of fibers of said material or in the form of a film deposited on the material or in the form of powder deposited on said material.

5. The process for manufacturing a fibrous material as claimed in claim 1, wherein the nanofillers of carbon origin/curing agent mixture advantageously comprises a content of nanofillers of between 10% and 60%, relative to the total weight of the mixture.

6. The process for manufacturing a fibrous material as claimed in claim 1, wherein the nanofillers of carbon origin consist of carbon nanotubes or carbon nanofibers or carbon black or graphenes or graphite or a mixture thereof.

7. The process for manufacturing a fibrous material as claimed in claim 1, wherein the curing agent is selected from amines, derivatives obtained by reaction of urea with a polyamine, acid anhydrides, organic acids, organic phosphates, polyols, and radical initiators such as peroxides or hydroperoxides.

8. The process for manufacturing a fibrous material as claimed in claim 1, wherein the nanofillers/curing agent mixture comprises one or more additives selected from: an accelerator, a catalyst, a thermoplastic polymer, and a blend of thermoplastic polymers.

9. The process for manufacturing a fibrous material as claimed in claim 8, wherein the mixture comprises the accelerator or catalyst, wherein
the catalyst is selected from: substituted benzoic acids and sulfone-containing acids, and
the accelerator is selected from: tertiary amines, monoethylamine associated with boron trifluoride (MEA-BF3), imidazoles, and metal alcoholates.

10. The process for manufacturing a fibrous material as claimed in claim 1, wherein the thermosetting polymer is selected from: unsaturated polyesters, epoxy resins, vinyl esters, multifunctional acrylate monomers or oligomers, acrylic/acrylate resins, phenolic resins, polyurethanes, cyanoacrylates and polyimides, aminoplasts and the blend of thermosetting polymers is selected from mixtures thereof.

11. The process for manufacturing a fibrous material as claimed in claim 1, wherein the impregnation is carried out by placing the fibrous material in a fluid bath of thermosetting polymer(s), into which the nanofillers/curing agent mixture is introduced.

12. The process for manufacturing a fibrous material as claimed in claim 3, wherein the impregnation is carried out by placing the fibrous material in a fluidized bed with the thermosetting polymer or the blend of thermosetting polymers that is in powder form and also the nanofillers/curing agent mixture.

13. The process for manufacturing a fibrous material as claimed in claim 3, wherein the impregnation is carried out by directly extruding a stream of thermosetting polymer containing the nanofillers/curing agent mixture over the fibrous material which is in the form of a sheet or strip or braid.

14. The process for manufacturing a fibrous material as claimed in claim 4, wherein the nanofillers/curing agent mixture is introduced directly into the fibrous material, the impregnation being carried out by placing the fibrous material in a fluidized bed with the thermosetting polymer or the blend of thermosetting polymers in powder form or by placing the fibrous material in a fluid bath of thermosetting polymer(s) or by depositing a film of thermosetting polymer on the fibrous material, followed by calendering and heating.

15. The process for manufacturing a fibrous material as claimed in claim 1, wherein the process comprises i) using at least two series of different fibers, a first series of continuous fibers forming the reinforcing fibers of said material and a second series of thermosetting polymer fibers containing the nanofillers/curing agent mixture and having a melting temperature Tm; ii) placing the two series of fibers in contact with one another, then iii) heating the set of the two series of fibers to a temperature at least equal to the melting temperature Tm of the thermosetting fibers and leaving the set to cool to ambient temperature, the melting temperature Tm being below the reaction temperature of the curing agent and below the melting temperature of the fibers of the first series.

16. The process for manufacturing a fibrous material as claimed in claim 15, wherein the reinforcing fibers constituting the first series are mineral fibers or organic fibers of thermoplastic or thermosetting polymer.

17. An appliance for implementing the process as claimed in claim 15, wherein the appliance comprises a line for continuous formation of said material in the form of at least one calibrated and homogeneous strip made of reinforcing fibers impregnated with thermosetting polymer, the line comprising:
a device for positioning the two series of fibers used to form a strip, so as to place the two series of fibers in contact with one another, the device being provided with a first calendering device; and
a shaping device, provided with a second calendering device, provided with two rolls comprising at least one pressing section of desired width, in order to obtain, via pressure, a strip that is calibrated in width during its passage through the rolls.

18. The appliance for implementing the process as claimed in claim 15, wherein a line for continuous formation of the fibrous material comprises inlets for several sets of two series of fibers and several shaping and width-calibrating sections so as to simultaneously form several calibrated and homogeneous strips of pre-impregnated fibrous material.

19. A process for the manufacture of parts having a three-dimensional structure, wherein the process comprises a step of shaping the pre-impregnated fibrous materials combined with a heating of these materials as obtained by a process as claimed in claim 1, to a temperature at least equal to the glass transition temperature Tg of the thermosetting polymer, in order to activate the reaction of the curing agent and crosslink the polymer in order to render the composition thermoset and give the part its final shape.

20. The process as claimed in claim 19, wherein said shaping of the fibrous materials comprises positioning the pre-impregnated fibrous materials on a preform, in staggered rows and so that the pre-impregnated fibrous materials are at least partly superposed until the desired thickness is obtained and in heating by means of a laser which also makes it possible to adjust the positioning of the fibrous materials relative to the preform, the preform then being removed.

21. The process as claimed in claim 19, wherein the shaping of the pre-impregnated materials is carried out by one of the following known techniques:
calendering,
laminating,
the pultrusion technique,
low-pressure injection Molding® or else,
the technique of filament winding,
infusion,
thermocompression,
RIM or S-RIM.
